(19) United States
(12) Patent Application Publication
(10) Pub. No.: US 2026/0355987 A1
(43) Pub. Date: Nov. 12, 2026

(54) VACUUM PAD AND HAND

(71) Applicant: SEMES CO., LTD., Cheonan-si (KR)

(72) Inventors: Ki Sang EUM, Cheonan-si (KR); Hak Jun KIM, Asan-si (KR); Wan Ho DO, Cheonan-si (KR)

(21) Appl. No.: 19/635,862

(22) Filed: Apr. 1, 2026

(30) Foreign Application Priority Data
May 8, 2025 (KR) 10-2025-0059473

(51) Int. Cl. B25J 15/06; B25J 15/00

(52) U.S. Cl. CPC B25J 15/0691; B25J 15/0014

(57) ABSTRACT

Provided are a vacuum pad and a hand. A vacuum pad according to an example embodiment includes: a pad assembly inserted into and installed in a suction hole of a substrate support body; and a protruding edge portion protruding from an upper surface edge of the pad assembly, and having a varying width or height, the protruding edge portion being a portion on which a substrate is seated.

### CROSS-REFERENCE TO RELATED APPLICATION(S)

This application claims benefit of priority to Korean Patent Application No. 10-2025-0059473 filed on May 8, 2025 in the Korean Intellectual Property Office, the disclosure of which is incorporated herein by reference in its entirety.

### BACKGROUND

### 1. Field

The present disclosure relates to a vacuum pad and hand for vacuum-suctioning a substrate.

2. Description of Related Art

To manufacture semiconductor devices and flat panel displays, various processes such as photolithography and cleaning are performed on substrates.

These processes are carried out inside processing chambers each having an independent space, and the substrate is conveyed to the processing chambers according to the respective processing procedures by a transfer device such as a conveyance robot. At this time, the transfer device transfers the substrate in a state where the substrate is vacuum-suctioned by a vacuum pad.

Meanwhile, the vacuum pad has a ring-shaped edge portion on which the substrate is seated, the edge portion having a regular structure that extends in a uniform form along a circular shape.

In this manner, since the edge portion of the vacuum pad takes a regular structure, a vacuum pressure for vacuum-suctioning a substrate is maintained at a constant level in an inner space of the vacuum pad.

However, there is a limitation in that, when the vacuum pressure of the vacuum pad is released, external atmospheric pressure cannot quickly penetrate between the edge portion of the vacuum pad and the substrate.

This may cause a problem in that, when the substrate is separated from the transfer device, the substrate cannot be quickly separated from the transfer device, and the substrate falls during a subsequent operation of the transfer device.

### SUMMARY

An aspect of the present disclosure is to provide a vacuum pad and a hand capable of quickly separating a substrate from the vacuum pad when a vacuum pressure of the vacuum pad is released.

According to an aspect of the present disclosure, a vacuum pad includes: a pad assembly inserted into and installed in a suction hole of a substrate support body; and a protruding edge portion protruding from an upper surface edge of the pad assembly, and having a varying width or height, the protruding edge portion being a portion on which a substrate is seated.

An upper surface of the protruding edge portion may have a width varying along the protruding edge portion.

A plurality of side grooves may be formed in a side surface of the protruding edge portion, and the plurality of side grooves may be formed to be spaced apart from each other along the protruding edge portion.

The protruding edge portion may be formed in a ring structure, and the plurality of side grooves may be formed in an inner circumferential surface or an outer circumferential surface of the protruding edge portion.

The plurality of side grooves may be formed in a curved structure.

A plurality of upper grooves may be formed in an upper surface of the protruding edge portion, and the plurality of upper grooves may be formed to be spaced apart from each other along the protruding edge portion.

The plurality of upper grooves may be formed in a curved structure.

A plurality of upper protrusions may be formed on an upper surface of the protruding edge portion, and the plurality of upper protrusions may be formed to be spaced apart from each other along the protruding edge portion.

The pad assembly may have a pad hole communicating with the suction hole of the substrate support body, and the pad hole may be disposed eccentrically in the pad assembly.

According to another aspect of the present disclosure, a hand includes: a substrate support body having a suction hole; and a vacuum pad installed in the suction hole, and configured to vacuum-suction a substrate, wherein the vacuum pad includes: a pad assembly inserted into and installed in the suction hole, and having a pad hole communicating with the suction hole; and a protruding edge portion protruding from an upper surface edge of the pad assembly, and having a varying width or height, the protruding edge portion being a portion on which the substrate is seated.

According to another aspect of the present disclosure, a hand includes: a substrate support body having a suction hole; and a vacuum pad installed in the suction hole, and configured to vacuum-suction a substrate, wherein the vacuum pad includes: a pad assembly inserted into and installed in the suction hole, and having a pad hole communicating with the suction hole; and a protruding edge portion protruding from an upper surface edge of the pad assembly, and having a varying width or height, the protruding edge portion being a portion on which the substrate is seated, wherein the pad assembly includes: a support pad having a pad body inserted into the suction hole and having an assembly hole, and a pad head horizontally extending from an upper portion of the pad body with the protruding edge portion formed thereon; a nut member having a nut body screwed into the assembly hole, and a nut head connected to the nut body with the pad hole formed vertically therein; and an O-ring installed in the pad assembly, and configured to seal a gap between an inner surface of the suction hole and the pad assembly.

The vacuum pad and the hand according to an example embodiment of the present disclosure can quickly separate a substrate from the vacuum pad when the vacuum pressure of the vacuum pad is released.

As a result, the present disclosure is capable of preventing the substrate from falling during a subsequent operation of a transfer device.

In this manner, the present disclosure is capable of preventing damage to the substrate and also shortening the substrate transfer time, thereby improving productivity in semiconductor manufacturing.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a view illustrating a hand according to the present disclosure;

FIG. 2 is a cross-sectional view illustrating a state in which a vacuum pad according to a first example embodiment is installed on a substrate support body of the hand of FIG. 1;

FIG. 3 is a perspective view illustrating the vacuum pad according to the first example embodiment of FIG. 2;

FIG. 4 is a plan view illustrating the vacuum pad of FIG. 3;

FIG. 5 is an enlarged view illustrating portion I of FIG. 3;

FIG. 6 is a perspective view illustrating a vacuum pad according to a second example embodiment;

FIG. 7 is a plan view illustrating the vacuum pad of FIG. 6;

FIG. 8 is an enlarged view illustrating portion II of FIG. 6;

FIG. 9 is a perspective view illustrating a vacuum pad according to a third example embodiment;

FIG. 10 is a side view illustrating the vacuum pad of FIG. 9;

FIG. 11 is a perspective view illustrating a vacuum pad according to a fourth example embodiment; and

FIG. 12 is a plan view illustrating a vacuum pad according to a fifth example embodiment.

### DETAILED DESCRIPTION

Hereinafter, preferred example embodiments will be described in detail with reference to the attached drawings so that those having ordinary knowledge in the art to which the present disclosure pertains can easily carry out the present disclosure. However, in describing the preferred example embodiments of the present disclosure in detail, detailed descriptions of relevant known functions or configurations will be omitted if deemed unnecessarily obscuring the gist of the present disclosure. In addition, parts performing similar functions and actions will be denoted by the same reference numerals throughout the drawings. In addition, in the present specification, the terms ‘on,’ ‘upper,’ ‘top,’ ‘under,’ ‘lower,’ ‘bottom,’ ‘side,’ and the like, are used based on the drawings, and may vary depending on directions in which components are actually disposed.

In addition, throughout the specification, when one part is described as being ‘connected’ to another part, this includes not only cases in which the parts are ‘directly connected’ but also cases in which the parts are ‘indirectly connected’ with another component interposed therebetween. Furthermore, throughout the specification, the term ‘include’ when used to describe a certain component means that other components may be further included, rather than excluding other components, unless specifically stated otherwise.

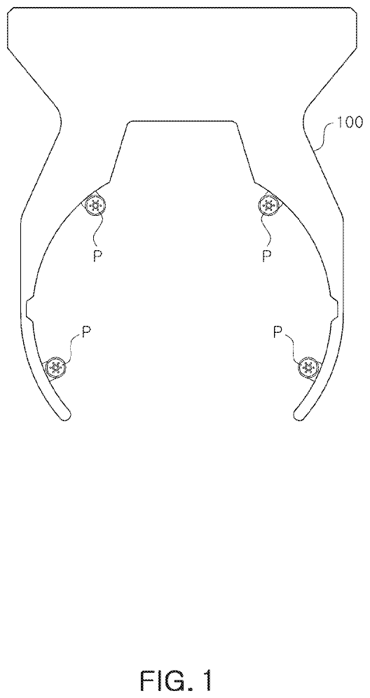

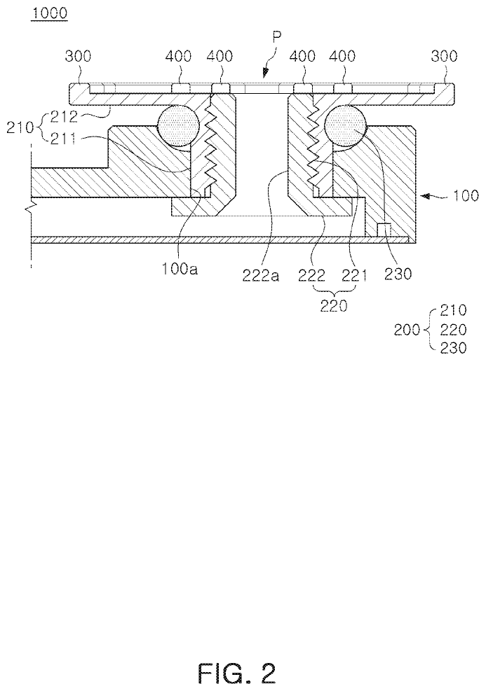

FIG. 1 is a view illustrating a hand according to the present disclosure, and FIG. 2 is a cross-sectional view illustrating a state in which a vacuum pad according to a first example embodiment is installed on a substrate support body of the hand of FIG. 1.

Referring to the drawing, a hand 1000 according to the present disclosure is a part of a transfer device that transfers a substrate, on which the substrate is seated, and includes a substrate support body 100 and a vacuum pad P.

The substrate support body 100 is configured to support an edge of a circular substrate so that the substrate can be stably seated.

As an example, the substrate support body 100 may extend in a curved shape on both sides to correspond to the shape of the edge of the substrate.

In addition, the vacuum pad P is installed on the substrate support body 100 to firmly fix the substrate seated on the substrate support body 100 using a vacuum suction force.

Specifically, the substrate support body 100 has a suction hole 100a, and the suction hole 100a is connected to a vacuum pump of the transfer device as a route through which air is sucked.

Here, the suction hole 100a is formed vertically, that is, in a longitudinal direction, in the substrate support body 100 at a portion where the vacuum pad P is installed, and is open outward on an upper side thereof.

The suction hole 100a may extend in a transverse direction on a lower side thereof to be connected to a vacuum cable of the vacuum pump.

The vacuum pad P is installed in the suction hole 100a of the substrate support body 100, and serves to vacuum-suction the seated substrate.

More specifically, the vacuum pad P may include a pad assembly 200, a protruding edge portion 300, and a center protrusion 400.

The pad assembly 200 may be inserted into and installed in the suction hole 100a of the substrate support body 100.

That is, the pad assembly 200 may be fixed in a structure in which the pad assembly 200 is inserted into the suction hole 100a formed vertically in the substrate support body 100.

In addition, the pad assembly 200 has a pad hole 222a communicating with the suction hole 100a of the substrate support body 100.

Specifically, the pad assembly 200 may include a support pad 210, a nut member 220, and an O-ring 230.

The support pad 210 may include a pad body 211 and a pad head 212.

The pad body 211 is inserted into the suction hole 100a of the substrate support body 100, and has an assembly hole 211a.

The pad head 212 extends horizontally from an upper portion of the pad body 211.

A protruding edge portion 300 and a plurality of center protrusions 400, which will be described below, may be formed on the pad head 212.

In addition, the nut member 220 may include a nut body 221 and a nut head 222.

The nut body 221 is screwed into the assembly hole 211a.

The nut head 222 extends horizontally from a lower portion of the nut body 221, and the pad hole 222a is formed vertically.

In addition, the O-ring 230 is installed in the pad assembly 200, and is configured to seal a gap between an inner surface of the suction hole 100a and the pad assembly 200.

Meanwhile, the protruding edge portion 300 is formed to protrude from an upper surface edge of the pad assembly 200.

In addition, the plurality of center protrusions 400 may be formed on the upper surface of the pad assembly 200 so as to be spaced apart from each other along the perimeter of the pad hole 222a. The plurality of center protrusions 400 serve to push the substrate so that the substrate can be easily separated from the vacuum pad P when the vacuum pressure of the vacuum pad P is released.

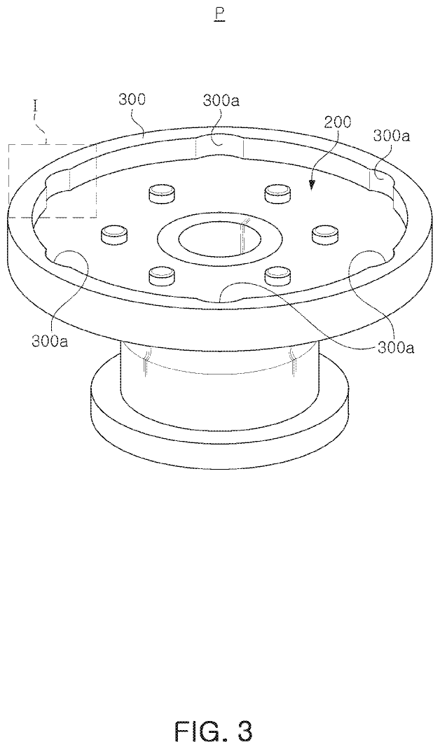

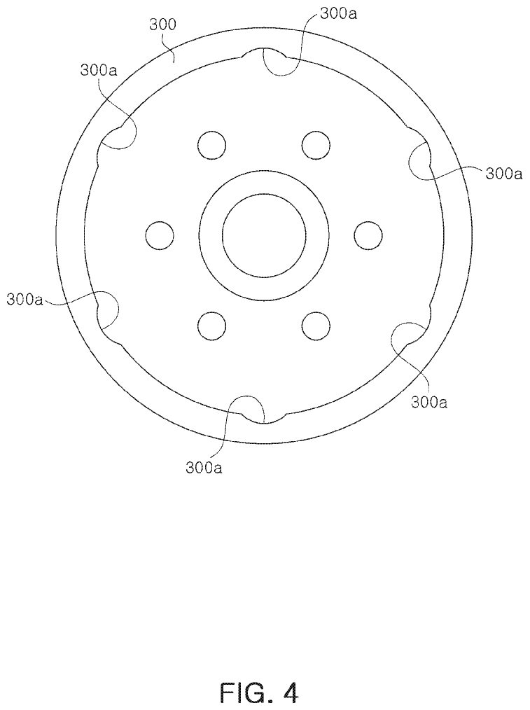

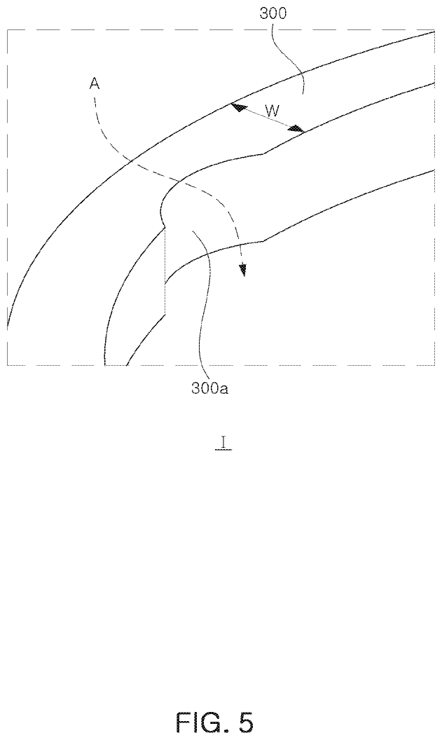

FIG. 3 is a perspective view illustrating the vacuum pad according to the first example embodiment of FIG. 2, FIG. 4 is a plan view illustrating the vacuum pad of FIG. 3, and FIG. 5 is an enlarged view illustrating portion I of FIG. 3.

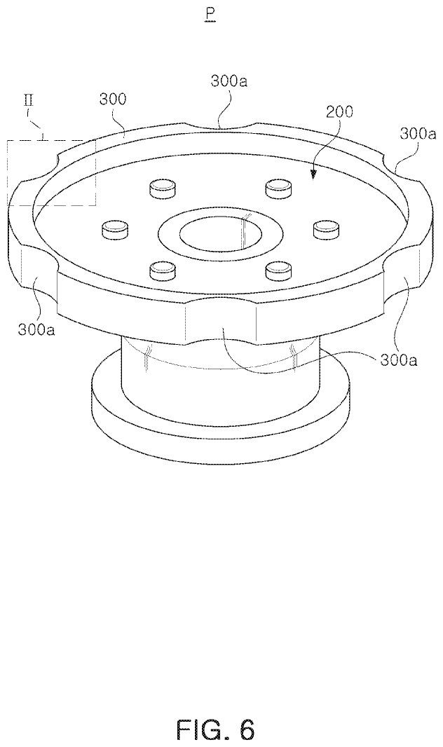

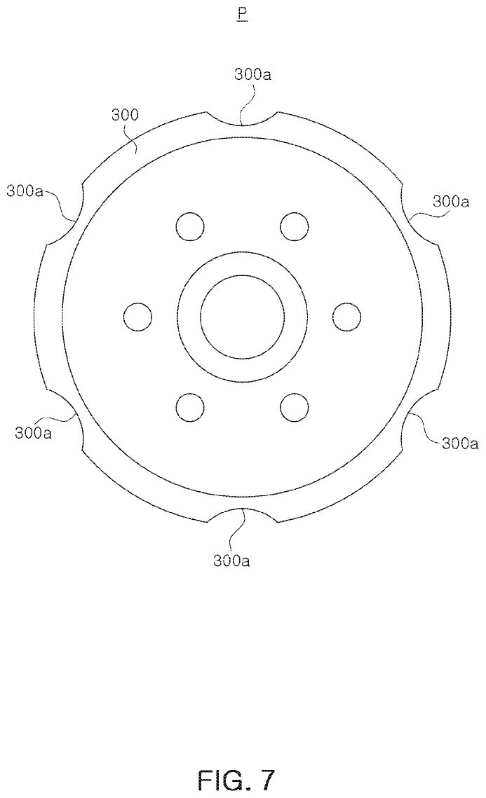

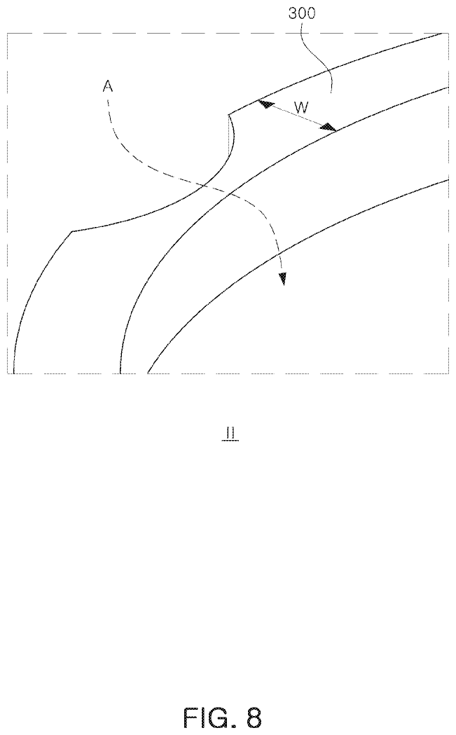

FIG. 6 is a perspective view illustrating a vacuum pad according to a second example embodiment, FIG. 7 is a plan view illustrating the vacuum pad of FIG. 6, and FIG. 8 is an enlarged view illustrating portion II of FIG. 6.

Referring to the drawings, the protruding edge portion 300 of the vacuum pad P is a portion of the pad assembly 200 on which the substrate is seated, and is a portion with which the substrate comes into contact when the hand holds the substrate.

The protruding edge portion 300 protrudes along the upper surface edge of the pad assembly 200, and has a varying width or height.

Specifically, the upper surface of the protruding edge portion 300 has a width W varying along the protruding edge portion 300.

That is, the width W of the upper surface of the protruding edge portion 300 may increase or decrease, not being uniform, along the protruding edge portion 300.

To this end, a plurality of side grooves 300a may be formed on a side surface of the protruding edge portion 300.

The plurality of side grooves 300a may be formed to be spaced apart from each other along the protruding edge portion 300.

Specifically, the protruding edge portion 300 may be formed in a ring structure, and the plurality of side grooves 300a may be formed on an inner circumferential surface 301 or an outer circumferential surface 302 of the protruding edge portion 300.

That is, the protruding edge portion 300 has an inner space by extending in a circular shape, and the plurality of side grooves 300a may be formed on a side surface of the inner space, which is the inner circumferential surface 301, or on an outer side surface, which is the outer circumferential surface 302.

In the vacuum pad P according to the first example embodiment, the plurality of side grooves 300a may be formed on the inner circumferential surface of the protruding edge portion 300, as illustrated in FIGS. 3 to 5.

In addition, in the vacuum pad P according to the second example embodiment, the plurality of side grooves 300a may be formed on the outer circumferential surface of the protruding edge portion 300, as illustrated in FIGS. 6 to 8.

In the first example embodiment and the second example embodiment, the plurality of side grooves 300a may be formed to be spaced apart from each other along the protruding edge portion 300.

In this manner, by forming the plurality of side grooves 300a along the protruding edge portion 300 on the inner circumferential surface of the protruding edge portion 300, the width W of the upper surface of the protruding edge portion 300 varies along the protruding edge portion 300.

In a portion of the protruding edge portion 300 where the side groove 300a is formed, the width W of the upper surface of the protruding edge portion 300 decreases.

When the vacuum pressure of the vacuum pad P is released, a gap between the substrate (not illustrated) and the protruding edge portion 300 can be easily formed at the portion where the width W of the upper surface of the protruding edge portion 300 decreases, as illustrated in FIGS. 5 and 8.

That is, when the vacuum pressure of the vacuum pad P is released, a path for external air A to penetrate between the substrate and the portion where the side groove 300a is formed and the width W of the upper surface of the protruding edge portion 300 decreases can be easily formed.

Accordingly, when the vacuum pressure of the vacuum pad P is released, the vacuum pressure of the vacuum pad P can be quickly relieved.

Therefore, when the substrate is separated from the transfer device, the substrate can be quickly separated from the transfer device, thereby preventing the substrate from falling during a subsequent operation of the transfer device.

In this manner, it is possible to prevent damage to the substrate, and it is also possible to shorten the substrate transfer time, thereby improving productivity in semiconductor manufacturing.

In particular, as in the first example embodiment illustrated in FIGS. 3 to 5, the vacuum pad P may have a structure that allows micro-leakage of vacuum pressure by forming the plurality of side grooves 300a on the inner circumferential surface of the protruding edge portion 300.

Accordingly, when the vacuum pressure of the vacuum pad P is released, the vacuum pressure of the vacuum pad P can be released very quickly.

Furthermore, in the first example embodiment and the second example embodiment, the plurality of side grooves 300a of the protruding edge portion 300 may be formed in a curved structure.

Such a curved structure preserves the durability of the protruding edge portion 300 as much as possible even though the plurality of side grooves 300a are formed in the protruding edge portion 300, thereby making it possible to firmly maintain the protruding edge portion 300 without being damaged over a long period of time.

Meanwhile, even though the plurality of side grooves 300a are formed in the protruding edge portion 300 as described above, the vacuum pad P can firmly fix the substrate during a substrate treatment process.

To this end, in order to secure a sufficient vacuum suction force of the vacuum pad P with respect to the substrate, the plurality of side grooves 300a may have a shape structure with an appropriate size, depth, number, etc.

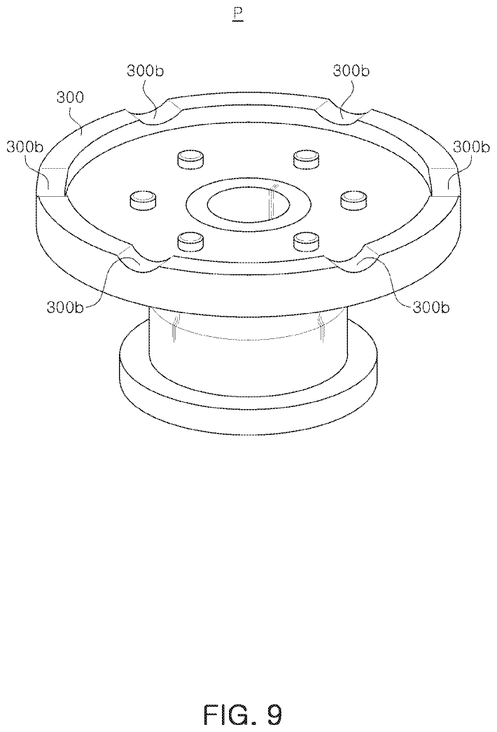

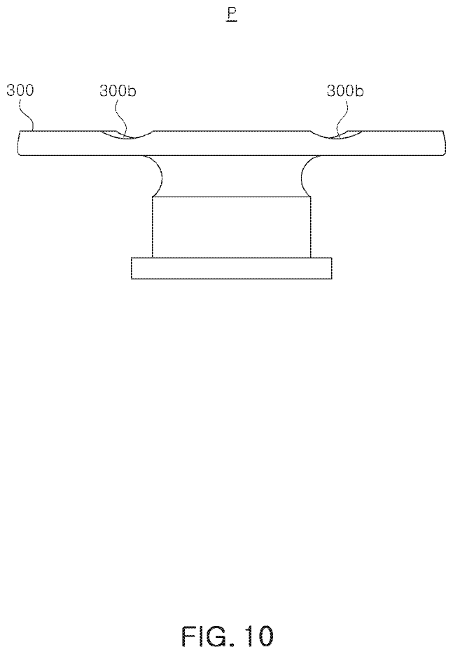

FIG. 9 is a perspective view illustrating a vacuum pad according to a third example embodiment, and FIG. 10 is a side view illustrating the vacuum pad of FIG. 9.

Referring to the drawings, a plurality of upper grooves 300b may be formed on the upper surface of the protruding edge portion 300 of the vacuum pad P.

The plurality of upper grooves 300b may be formed to be spaced apart from each other along the protruding edge portion 300.

In this manner, by forming the plurality of upper grooves 300b along the protruding edge portion 300 on the upper surface of the protruding edge portion 300, the upper surface of the protruding edge portion 300 has a height varying along the protruding edge portion 300.

In a portion of the protruding edge portion 300 where the upper groove 300b is formed, the height of the upper surface of the protruding edge portion 300 decreases.

When the vacuum pressure of the vacuum pad P is released, a gap between the substrate and the protruding edge portion 300 can be easily formed at the portion where the height of the upper surface of the protruding edge portion 300 decreases.

That is, when the vacuum pressure of the vacuum pad P is released, a path for external air to penetrate between the substrate and the portion where the height of the upper surface of the protruding edge portion 300 decreases can be easily formed.

Accordingly, when the vacuum pressure of the vacuum pad P is released, the vacuum pressure of the vacuum pad P can be quickly relieved.

Therefore, when the substrate is separated from the transfer device, the substrate can be quickly separated from the transfer device, thereby preventing the substrate from falling during a subsequent operation of the transfer device.

In this manner, it is possible to prevent damage to the substrate, and it is also possible to shorten the substrate transfer time, thereby improving productivity in semiconductor manufacturing.

The plurality of upper grooves 300b of the protruding edge portion 300 may be formed in a curved structure.

Such a curved structure can preserve the durability of the protruding edge portion 300 as much as possible even though the plurality of upper grooves 300b are formed in the protruding edge portion 300.

As a result, the protruding edge portion 300 can be firmly maintained without being damaged over a long period of time.

Meanwhile, even though the plurality of upper grooves 300b are formed in the protruding edge portion 300 as described above, the vacuum pad P can firmly fix the substrate during a substrate treatment process.

To this end, in order to secure a sufficient vacuum suction force of the vacuum pad P with respect to the substrate, the plurality of upper grooves 300b may have a shape structure with an appropriate size, depth, number, etc.

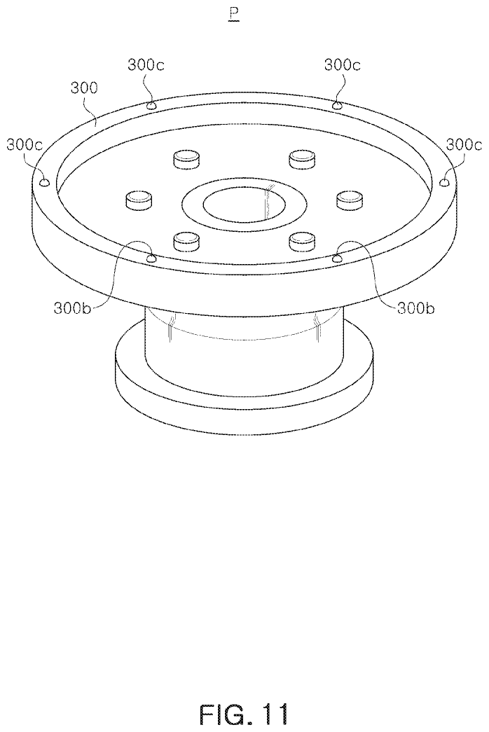

FIG. 11 is a perspective view illustrating a vacuum pad according to a fourth example embodiment.

Referring to the drawing, a plurality of upper protrusions 300c may be formed on the upper surface of the protruding edge portion 300 of the vacuum pad P.

The plurality of upper protrusions 300c may be formed to be spaced apart from each other along the protruding edge portion 300.

In this manner, by forming the plurality of upper protrusions 300c along the protruding edge portion 300 on the upper surface of the protruding edge portion 300, the height of the upper portion of the protruding edge portion 300 varies along the protruding edge portion 300.

In a portion of the protruding edge portion 300 where the upper protrusion 300c is formed, the height of the upper surface of the protruding edge portion 300 increases.

When the vacuum pressure of the vacuum pad P is released, a gap between the substrate and the protruding edge portion 300 can be easily formed due to a height difference in the upper portion of the protruding edge portion 300.

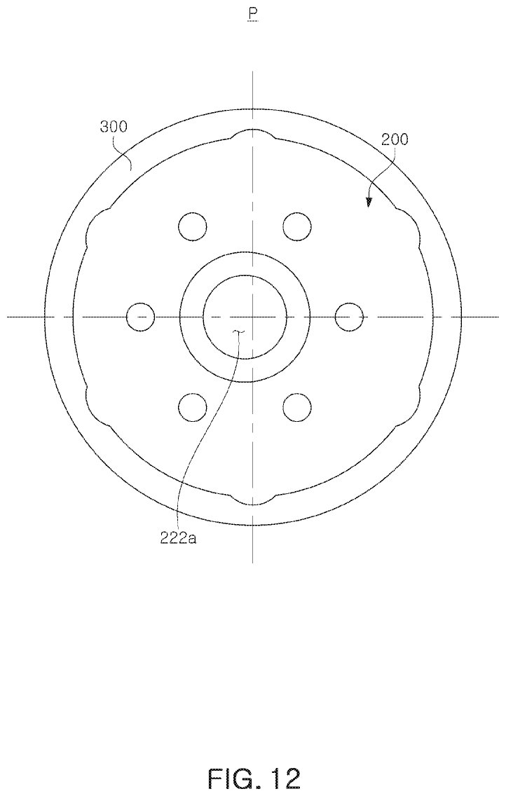

FIG. 12 is a plan view illustrating a vacuum pad according to a fifth example embodiment.

Referring to the drawing, the pad assembly 200 of the vacuum pad P has a pad hole 222a (in FIGS. 2 and 12) communicating with the suction hole 100a (in FIG. 2) of the substrate support body 100 (in FIG. 2), and the pad hole 222a may be disposed eccentrically in the pad assembly 200.

In this manner, by eccentrically disposing the pad hole 222a in the pad assembly 200, the pad hole 222a can be relatively closer to one side portion of the protruding edge portion 300.

The pad hole 222a is a passage for sucking air to generate a vacuum suction force with respect to the substrate.

Since the pad hole 222a is closer to one side portion of the protruding edge portion 300 than to the other side portion of the protruding edge portion 300, when the vacuum pressure of the vacuum pad P is released, a path for external air to penetrate between one side portion of the protruding edge portion 300 and the substrate can be easily formed.

Accordingly, when the vacuum pressure of the vacuum pad P is released, the vacuum pressure of the vacuum pad P can be quickly relieved.

While example embodiments have been shown and described above, it will be apparent to those skilled in the art that modifications and variations could be made without departing from the scope of the present invention as defined by the appended claims.

What is claimed is:

1. A vacuum pad comprising:
a pad assembly inserted into and installed in a suction hole of a substrate support body; and
a protruding edge portion protruding from an upper surface edge of the pad assembly, and having a varying width or height, the protruding edge portion being a portion on which a substrate is seated.

2. The vacuum pad according to claim 1, wherein an upper surface of the protruding edge portion has a width varying along the protruding edge portion.

3. The vacuum pad according to claim 2, wherein a plurality of side grooves are formed in a side surface of the protruding edge portion, and
the plurality of side grooves are formed to be spaced apart from each other along the protruding edge portion.

4. The vacuum pad according to claim 3, wherein the protruding edge portion is formed in a ring structure, and
the plurality of side grooves are formed in an inner circumferential surface or an outer circumferential surface of the protruding edge portion.

5. The vacuum pad according to claim 3, wherein the plurality of side grooves are formed in a curved structure.

6. The vacuum pad according to claim 1, wherein a plurality of upper grooves are formed in an upper surface of the protruding edge portion, and
the plurality of upper grooves are formed to be spaced apart from each other along the protruding edge portion.

7. The vacuum pad according to claim 6, wherein the plurality of upper grooves are formed in a curved structure.

8. The vacuum pad according to claim 1, wherein a plurality of upper protrusions are formed on an upper surface of the protruding edge portion, and
the plurality of upper protrusions are formed to be spaced apart from each other along the protruding edge portion.

9. The vacuum pad according to claim 1, wherein the pad assembly has a pad hole communicating with the suction hole of the substrate support body, and
the pad hole is disposed eccentrically in the pad assembly.

10. A hand comprising:
a substrate support body having a suction hole; and
a vacuum pad installed in the suction hole, and configured to vacuum-suction a substrate,
wherein the vacuum pad includes:
a pad assembly inserted into and installed in the suction hole, and having a pad hole communicating with the suction hole; and
a protruding edge portion protruding from an upper surface edge of the pad assembly, and having a varying width or height, the protruding edge portion being a portion on which the substrate is seated.

11. The hand according to claim 10, wherein a plurality of side grooves are formed in a side surface of the protruding edge portion, and
the plurality of side grooves are formed to be spaced apart from each other along the protruding edge portion, and an upper surface of the protruding edge portion has a width varying along the protruding edge portion.

12. The hand according to claim 11, wherein the protruding edge portion is formed in a ring structure, and
the plurality of side grooves are formed in an inner circumferential surface or an outer circumferential surface of the protruding edge portion.

13. The hand according to claim 11, wherein the plurality of side grooves are formed in a curved structure.

14. The hand according to claim 10, wherein a plurality of upper grooves are formed in an upper surface of the protruding edge portion, and
the plurality of upper grooves are formed to be spaced apart from each other along the protruding edge portion.

15. The hand according to claim 14, wherein the plurality of upper grooves are formed in a curved structure.

16. The hand according to claim 10, wherein a plurality of upper protrusions are formed on an upper surface of the protruding edge portion, and
the plurality of upper protrusions are formed to be spaced apart from each other along the protruding edge portion.

17. The hand according to claim 10, wherein the pad hole is disposed eccentrically in the pad assembly.

18. A hand comprising:
a substrate support body having a suction hole; and
a vacuum pad installed in the suction hole, and configured to vacuum-suction a substrate,
wherein the vacuum pad includes:
a pad assembly inserted into and installed in the suction hole, and having a pad hole communicating with the suction hole; and
a protruding edge portion protruding from an upper surface edge of the pad assembly, and having a varying width or height, the protruding edge portion being a portion on which the substrate is seated,
wherein the pad assembly includes:
a support pad having a pad body inserted into the suction hole and having an assembly hole, and a pad head horizontally extending from an upper portion of the pad body with the protruding edge portion formed thereon;
a nut member having a nut body screwed into the assembly hole, and a nut head connected to the nut body with the pad hole formed vertically therein; and
an O-ring installed in the pad assembly, and configured to seal a gap between an inner surface of the suction hole and the pad assembly.

19. The hand according to claim 18, wherein a plurality of side grooves are formed in a side surface of the protruding edge portion, and
the plurality of side grooves are formed to be spaced apart from each other along the protruding edge portion, and an upper surface of the protruding edge portion has a width varying along the protruding edge portion.

20. The hand according to claim 19, wherein the plurality of side grooves are formed in a curved structure.
